(19) United States
(12) Patent Application Publication
(10) Pub. No.: US 2013/0234820 A1
(43) Pub. Date: Sep. 12, 2013

(54) COMMON MODE FILTER AND FABRICATION METHOD THEREOF

(71) Applicants: Young Seuck YOO, Suwon-si-Gyeonggi-do (KR); Sung Kwon WI, Suwon-si-Gyeonggi-do (KR); Jong Yun LEE, Suwon-si-Gyeonggi-do (KR); Sang Moon LEE, Suwon-si-Gyeonggi-do (KR); Won Chul SIM, Suwon-si-Gyeonggi-do (KR); Jeong Bok KWAK, Suwon-si-Gyeonggi-do (KR); Kang Heon HUR, Suwon-si-Gyeonggi-do (KR); Yong Suk KIM, Suwon-si-Gyeonggi-do (KR)

(72) Inventors: Young Seuck YOO, Suwon-si-Gyeonggi-do (KR); Sung Kwon WI, Suwon-si-Gyeonggi-do (KR); Jong Yun LEE, Suwon-si-Gyeonggi-do (KR); Sang Moon LEE, Suwon-si-Gyeonggi-do (KR); Won Chul SIM, Suwon-si-Gyeonggi-do (KR); Jeong Bok KWAK, Suwon-si-Gyeonggi-do (KR); Kang Heon HUR, Suwon-si-Gyeonggi-do (KR); Yong Suk KIM, Suwon-si-Gyeonggi-do (KR)

(73) Assignee: SAMSUNG ELECTRO-MECHANICS CO., LTD., Suwon-si-Gyeonggi-do (KR)

(21) Appl. No.: 13/777,591

(22) Filed: Feb. 26, 2013

(30) Foreign Application Priority Data
Mar. 12, 2012 (KR) 10-2012-0025162

(51) Int. Cl. H01F 27/28; H01F 41/00

(52) U.S. Cl. CPC H01F 27/2804; H01F 41/00
USPC 336/200; 29/602.1

(57) ABSTRACT

Disclosed herein are a common mode filter and a fabrication method thereof. The common mode filter includes: a first magnetic substrate; a laminate including insulating sheets with coil pattern electrodes printed thereon, having holes therein, and provided on the first magnetic substrate; a magnetic core inserted into the hole; and a second magnetic substrate integrally formed with the magnetic core and provided on the laminate.

### CROSS REFERENCE(S) TO RELATED APPLICATIONS

This application claims the benefit under 35 U.S.C. Section 119 of Korean Patent Application Serial No. 10-2012-0025162, entitled “Common Mode Filter and Fabrication Method Thereof” filed on Mar. 12, 2012, which is hereby incorporated by reference in its entirety into this application.

### BACKGROUND OF THE INVENTION

1. Technical Field

The present invention relates to a common mode filter and a fabrication method thereof, and more particularly, to a common mode filter in which a magnetic core and a magnetic substrate are integrally formed, and a fabrication method thereof.

2. Description of the Related Art

The recent system configuration and an increase in a data capacity require a higher transfer rate. For a fast transmission, a differential signaling method is commonly used. In general, if a signal is made to have a high frequency to increase a transfer rate, undesired electromagnetic waves (i.e., noise) are generated, which cause a signal and noise to overlap. This results in a generation of common mode noise due to non-uniformity between high speed differential signal lines (i.e., two signal lines).

In order to cancel such common mode noise, a common mode filter is largely used. The common mode filter is an EMI filter mainly applied to the high speed differential signal lines.

Common mode noise is generated from differential signal lines, and the common mode filter cancels such noise which cannot be readily removed by an existing EMI filter. The common mode filter contributes to improvement of EMC characteristics of home appliances, or the like, or improvement of antenna characteristics of mobile phones, or the like. However, when a large amount of data is transmitted and received at a high frequency band of GHz between a main device and a peripheral device, there is a problem in smoothly processing data due to signal delay or other interference as mentioned above. In particular, when various communication, video sound signal lines are variably connected in a port-to-port manner and used like a digital TV, problems such as the foregoing internal signal line delay and transmission and reception distortion may arise frequently.

Thus, in an effort to solve this problem, the existing EMI countermeasure component (e.g., the common mode filter) is fabricated as a winding type EMI countermeasure component or a stacked type EMI countermeasure component, but the winding type or the stacked type EMI countermeasure component has chip components with large dimensions and poor electrical characteristics, so they are limitedly applied to a particular portion or a large-scale circuit board.

In addition, the recent electronic products are switching to those which are thinner, smaller, complexed, and multifunctional, so EMI countermeasure components in conformity with such functions have emerged. Winding type or stacked type EMI countermeasure components which correspond to the electronic products that are thinner, smaller, and the like, are fabricated, but there is a limitation in forming a complicated internal circuit in a small area, so recently, a thin film type common mode filter is required to be fabricated.

As for coil components, in order to enhance electrical characteristics of coil components, it is important to increase electromagnetic coupling between a primary coil and a secondary coil, and in order to increase electromagnetic coupling between the primary and secondary coils, a distance between the two coils is reduced or a magnetic circuit should be formed such that a leakage flux is not generated. In case of a thin film type common mode filter, since it is fabricated according to a thin film formation technique such as sputtering, evaporation, or the like, the distance between the primary and secondary coils can be reduced to be as small as a few advantageously increasing electromagnetic coupling and reducing the size of the components in comparison to the related art product, but high-priced equipment is required and productivity is degraded.

In this connection, Korean Patent Laid Open Publication No. 10-2002-0059899 (hereinafter, referred to as ‘Related Art Document’) proposes a coil component including at least two or more internal electrode layers, in which a non-magnetic electrode layer formed on at least one of the upper and lower surfaces and having an electrode pattern shape and an internal magnetic layer positioned at a central opening of the non-magnetic electrode layer and positioned on the lateral surface of the non-magnetic electrode layer form a single unit, a cover layer in contact with both sides of the internal electrode layers, and an external electrode terminal connected to a portion of the electrode pattern shape.

A method of fabricating such a coil component is described as follows. First, a green sheet formed by forming a magnetic film on a carrier film and a green sheet formed by forming a non-magnetic film on a carrier film are prepared respectively.

Next, a cutting line is formed on the magnetic film sheet and the non-magnetic film green sheet, and a via hole is formed in the non-magnetic film green sheet with the cutting line formed thereon.

And then, an electrode pattern is formed on an upper surface of the non-magnetic film green sheet with the via hole formed therein, and unnecessary portions are eliminated from the magnetic film and the non-magnetic film green sheets.

Thereafter, the magnetic film green sheet, the magnetic film green sheet with the cutting line formed thereon, the non-magnetic film green sheet with the cutting line formed thereon, and the non-magnetic film green sheet with the via hole and the electrode pattern formed thereon are laminated, the laminate is fired, and then, an electrode terminal is formed on an outer surface of the fired laminate, thus fabricating the proposed coil component.

However, in the case of the dry fabrication method as mentioned above, it is very difficult to stably form a vertical interface between the non-magnetic element and the magnet element, and in particular, it is very difficult to appropriately adjust the thickness of the internal electrode, the thickness of the non-magnetic element, and the thickness of the magnetic element in a vertical direction. Thus, weak structural stability may cause a problem with insulating characteristics between coils, or the like.

Also, since the magnetic element and the non-magnetic element should be punched in every layer and the magnetic element and the non-magnetic element should be half-cut and then laminated to form a single layer, the fabrication method is complicated and fabrication costs are increased.

### RELATED ART DOCUMENT

### Patent Document

(Patent Document 1) Patent Document: Korean Patent Laid Open Publication No. 10-2002-0059899

### SUMMARY OF THE INVENTION

An object of the present invention is to provide a common mode filter in which a magnetic core inserted in a hole formed on a laminate is integrally formed with a magnetic substrate, and a fabrication method thereof.

According to an exemplary embodiment of the present invention, there is provided a common mode filter, including: a first magnetic substrate; a laminate including insulating sheets with coil pattern electrodes printed thereon, having holes therein, and provided on the first magnetic substrate; a magnetic core inserted into the hole; and a second magnetic substrate integrally formed with the magnetic core and provided on the laminate.

The coil pattern electrodes may be printed on the insulating sheets such that the electrodes are wound around the magnetic core.

The laminate may include: a first insulating sheet with first and second leading electrodes printed thereon; a second insulating sheet laminated on the first insulating sheet and having a first coil pattern electrode printed thereon; a third insulating sheet laminated on the second insulating sheet and having a second coil pattern electrode printed thereon; and a fourth insulating sheet laminated on the third insulating sheet.

One end of the first leading electrode may be connected to one end of the first coil pattern electrode through a first via hole formed in the second insulating sheet, and one end of the second leading electrode may be connected to one end of the second coil pattern electrode through a second via hole formed in the second insulating sheet.

The common mode filter may further include: an external electrode terminal formed on a lateral surface of the laminate and connected to the other ends of the first and second leading electrodes and the other ends of the first and second coil pattern electrodes.

The first and second leading electrodes and the first and second coil pattern electrodes may be made of at least one material selected from the group consisting of silver (Ag), palladium (Pd), aluminum (Al), nickel (Ni), titanium (Ti), gold (Au), copper (Cu), and platinum (Pt), or a mixture of at least two materials thereof.

The thickness of the magnetic core may be equal to that of the laminate, and the shape and size of the magnetic core may be the same as the shape and size of the hole.

The first and second magnetic substrates may be made of at least one material selected from the group consisting of aluminum oxide (Al₂O₃), aluminum nitride (AlN), glass, quartz, and ferrite, or a mixture of at least two materials thereof.

The insulating sheet may be made of at least one material selected from the group consisting of polyimide, an epoxy resin, a benzocyclobutene (BCB), and a polymer, or a mixture of at least two materials thereof.

According to another exemplary embodiment of the present invention, there is provided a method of fabricating a common mode filter, including: providing a first magnetic substrate and a second magnetic substrate having a magnetic core formed to be outwardly protruded; providing a laminate configured of insulating sheets with coil pattern electrodes printed thereon on the first magnetic substrate; forming a hole in the laminate; and bonding the second magnetic substrate to the laminate such that the magnetic core is inserted into the hole.

The laminate may be formed by performing: printing first and second leading electrodes on a first insulating sheet; printing a first coil pattern electrode on a second insulating sheet; printing a second coil pattern electrode on a third insulating sheet; and sequentially depositing the first to third insulating sheets and the fourth insulating sheet starting from a lower surface thereof.

The first and second leading electrodes and the first and second coil pattern electrodes may be printed by any one of photolithography, e-beam, focused ion-beam, lithography, dry etching, wet etching, and nano-implant.

The forming of the hole in the laminate may be performed by using any one of a wet etching method, a dry etching method, and a sand blast method, or by using two or more methods thereof.

### BRIEF DESCRIPTION OF THE DRAWINGS

FIG. 1 is an exploded perspective view of a common mode filter according to an exemplary embodiment of the present invention.

FIG. 2 is a cross-sectional view of a second magnetic substrate constituting the common mode filter according to an exemplary embodiment of the present invention.

FIG. 3 is an external perspective view of the common mode filter according to an exemplary embodiment of the present invention.

FIGS. 4A to 4E are cross-sectional views sequentially showing a method of fabricating the common mode filter according to an exemplary embodiment of the present invention.

### DESCRIPTION OF THE PREFERRED EXEMPLARY EMBODIMENTS

Various advantages and features of the present invention and methods accomplishing thereof will become apparent from the following description of embodiments with reference to the accompanying drawings. However, the present invention may be modified in many different forms and it should not be limited to the embodiments set forth herein. These embodiments may be provided so that this disclosure will be thorough and complete, and will fully convey the scope of the invention to those skilled in the art. Like reference numerals throughout the description denote like elements.

Terms used in the present specification are for explaining the embodiments rather than limiting the present invention. Unless explicitly described to the contrary, a singular form includes a plural form in the present specification. The word “comprise” and variations such as “comprises” or “comprising,” will be understood to imply the inclusion of stated constituents, steps, operations and/or elements but not the exclusion of any other constituents, steps, operations and/or elements.

Hereinafter, a configuration and an acting effect of exemplary embodiments of the present invention will be described in more detail with reference to the accompanying drawings.

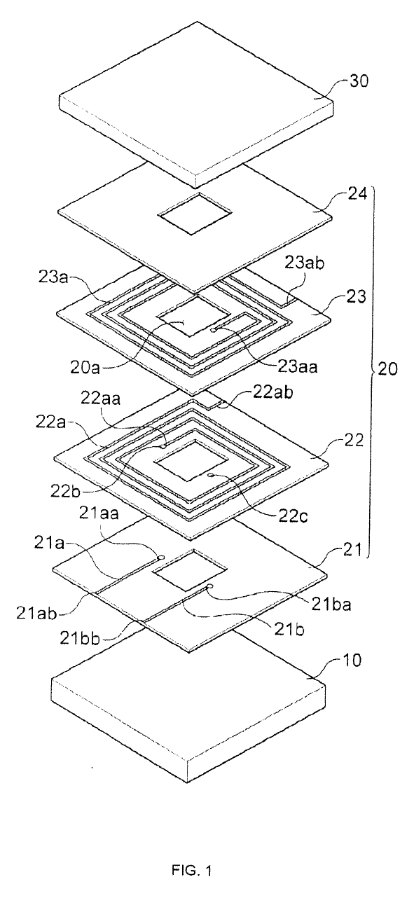

FIG. 1 is an exploded perspective view of a common mode filter according to an exemplary embodiment of the present invention.

With reference to FIG. 1, the common mode filter includes a first magnetic substrate 10, a laminate 20, a second magnetic substrate 30.

The first magnetic substrate 10 is formed to have an extended plate-body shape and serves as a base substrate in a completed common mode filter. Namely, in the completed common mode filter, the first magnetic substrate 10 makes a pair with the second magnetic substrate 30, and the first magnetic substrate and the second magnetic substrate 30 are positioned at the uppermost portion and the lowermost portion of the common mode filter, respectively.

The first magnetic substrate 10 is made of a magnetic material and forms a magnetic loop. Thus, a magnetic substrate having high magnetic permeability, a high quality coefficient, and high high frequency impedance is preferably used, and specifically, such a magnetic substrate may be made of at least one material selected from the group consisting of aluminum oxide (Al₂O₃), aluminum nitride (AlN), glass, quartz, and ferrite, or a mixture of at least two materials thereof.

The laminate 20 is provided on the first magnetic substrate 10.

The laminate 20 is layers formed by laminating insulating sheets with a coil pattern electrode printed thereon. Specifically, the laminate 20 includes a first insulating sheet 21 with a first leading electrode 21a and a second leading electrode 21b printed thereon, a second insulating sheet 22 with a first coil pattern electrode 22a printed thereon, a third insulating sheet 23 with a second coil pattern electrode 23a printed thereon, and a fourth insulating sheet 24.

The first, second, third, and fourth insulating sheets 21, 22, 23, and 24 serve to provide adhesive force between the respective insulating sheets 21, 22, 23, and 24, between the first insulating sheet 21 and the first magnetic substrate 10, and between the fourth insulating sheet 24 and the second magnetic substrate 30, prevent the first and second coil pattern electrodes 22a and 23a from being short-circuited, and lessen an irregular configuration due to the first and second coil pattern electrodes 22a and 23a.

The first, second, third, and fourth insulating sheets 21, 22, 23, and 24 may be made of at least one material selected from the group consisting of polyimide, an epoxy resin, a benzocyclobutene (BCB), and a polymer, or a mixture of at least two materials thereof.

The first and second leading electrodes 21a and 21b and the first and second coil pattern electrodes 22a and 23a may be made of at least one material selected from the group consisting of silver (Ag), palladium (Pd), aluminum (Al), nickel (Ni), titanium (Ti), gold (Au), copper (Cu), and platinum (Pt), or a mixture of at least two materials thereof and may be implemented to have various shapes. In FIG. 1, pattern electrodes printed to have a spiral line shape are illustrated.

As for a connection structure of the laminate 20, first and second via holes 22b and 22c are formed in the second insulating sheet 22, and one end 21aa of the first leading electrode 21a is connected to one end 22aa of the first coil pattern electrode 22a through the first via hole 22b, and one end 21ba of the second leading electrode 21b is connected to one end 23aa of the second coil pattern electrode 23a through the second via hole 22c.

A hole 20a, a space through which a magnetic core is to be inserted (to be described), is formed at a central portion of the laminate 20.

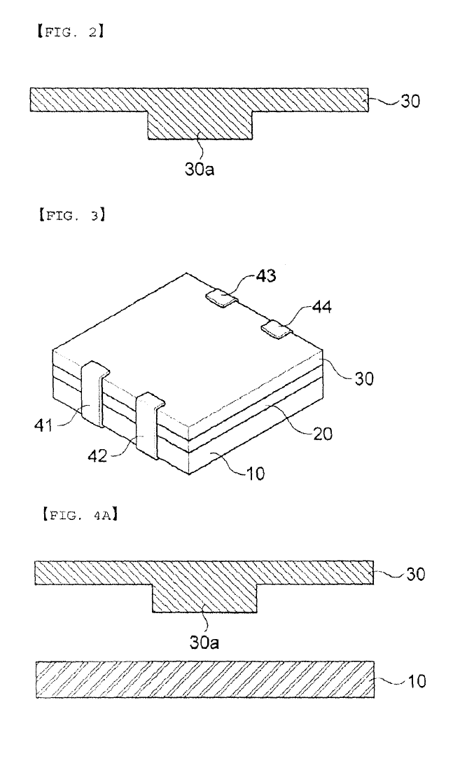

The second magnetic substrate 30 is provided on the laminate 20. The configuration of the second magnetic substrate 30 will be described with reference to FIG. 2. A magnetic core 30a is formed to be outwardly protruded from a central portion of the second magnetic substrate 30. Accordingly, the second magnetic substrate 30, with the magnetic core 30a inserted into the hole 20a formed in the laminate 20, is provided on the laminate 20, and the first and second coil pattern electrodes 22a and 23a are configured to be wound around the magnetic core 30a.

An effect obtained by integrally forming the second magnetic substrate 30 and the magnetic core 30a will be described in detail in a method of fabricating a common mode filter according to an exemplary embodiment of the present invention hereafter.

In order to allow the magnetic core 30a to be inserted into the hole 20a, preferably, the thickness of the magnetic core 30a is equal to that of the laminate 20, and the shape and size of the magnetic core 30a are the same as those of the hole 20a. Here, the magnetic core 30a may have various shapes, and in FIG. 1 the magnetic core 30a is illustrated to have a square pillar shape according to the first and second coil pattern electrodes 22a and 23a having a linear shape.

The magnetic core 30a may be made of at least one material selected from the group consisting of aluminum oxide (Al₂O₃), aluminum nitride (AlN), glass, quartz, and ferrite, or a mixture of at least two materials thereof, which has high magnetic permeability, a high quality coefficient, and high high frequency impedance. If the size of the magnetic core 30a is too small, an effect desired to be implemented would be insufficient, and conversely, if the size of the magnetic core 30a is too large, it is detrimental for reducing the size of a product and may cause a problem of a short-circuit with the coil pattern electrodes. Thus, the magnetic core 30a is formed to have an appropriate size in consideration of the size of a product.

Like the first magnetic substrate 10 and the magnetic core 30a, the second magnetic substrate 30 may be made of at least one material selected from the group consisting of aluminum oxide (Al₂O₂), aluminum nitride (AlN), glass, quartz, and ferrite, or a mixture of at least two materials thereof.

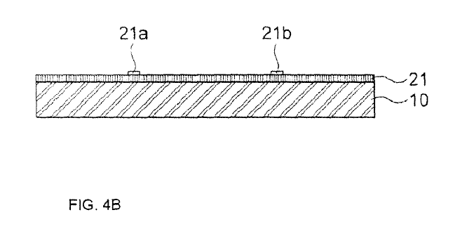

FIG. 3 is an external perspective view of the common mode filter according to an exemplary embodiment of the present invention. As shown in FIG. 3, the common mode filter according to an exemplary embodiment of the present invention may further include external electrode terminals 41, 42, 43, and 44 formed on the lateral surfaces of the laminate 20 and connected to the first and second leading electrodes 21a and 21b and the first and second coil pattern electrodes 22a and 23a, respectively.

With reference to FIGS. 1 and 3, the other end 21ab of the first leading element 21a is connected to the external electrode terminal 41, the other end 21bb of the second leading electrode 21b is connected to the external electrode terminal 42. An electrode 22ab drawn from the other end of the first coil pattern electrode 22a is connected to the external electrode terminal 43, and an electrode 23ab drawn from the other end of the second coil pattern electrode 23a is connected to the external electrode terminal 44. Accordingly, the first and second coil pattern electrodes 22a and 23a may be electrically connected to an external circuit through the external electrode terminals 41, 42, 43, and 44.

A method of fabricating a common mode filter according to an exemplary embodiment of the present invention will be described.

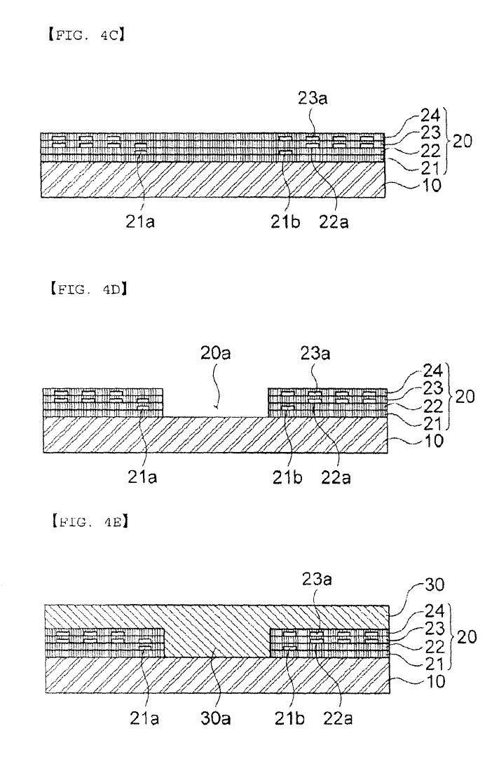

FIGS. 4A to 4E are cross-sectional views sequentially showing a method of fabricating the common mode filter according to an exemplary embodiment of the present invention.

With reference to FIG. 4A, in the method of fabricating a common mode filter according to an exemplary embodiment of the present invention, first, the first magnetic substrate 10 and the second magnetic substrate 30 having the magnetic core 30a formed to be protruded from the central portion thereof are provided.

The first and second magnetic substrates 10 and 30 may be formed through an injection molding process of injecting slurry made of at least one material selected from the group consisting of aluminum oxide (Al₂O₃), aluminum nitride (AlN), glass, quartz, and ferrite, or a mixture of at least two materials thereof into a mold, curing the slurry under certain conditions, and removing the mold.

Next, the laminate 20 configured of insulating sheets with coil pattern electrodes printed thereon is disposed on the first magnetic substrate 10.

The process of laminating the laminate 20 on the first magnetic substrate 10 will be described in detail. First, as shown in FIG. 4B, the first insulating sheet 21 is deposited on the first magnetic substrate 10.

The first insulating sheet 21 includes the first leading electrode 21a and the second leading electrode 21b printed on an upper surface thereof, and here, the first leading electrode 21a and the second leading electrode 21b may be printed on the first insulating sheet 21 according to a scheme generally known in the art to which the present invention pertains. For example, in an exemplary embodiment of the present invention, any one of photolithography, e-beam, focused ion-beam, lithography, dry etching, wet etching, and nano-implant may be performed to print the first leading electrode 21a and the second leading electrode 21b on the first insulating sheet 21.

After the first coil pattern electrode 22a is printed on the second insulating sheet 22 and the second coil pattern electrode 23a is printed on the third insulating sheet 23, the second and third insulating sheets 22 and 23 are sequentially deposited on the first insulating sheet 21, and finally, the fourth insulating sheet 24 is deposited on the third insulating sheet 23, thereby forming the laminate 20 on the first magnetic substrate 10 as shown in FIG. 4C. The deposition process may be performed through a general thin film formation technique such as screen printing, spin coating, or the like, and such a thin film formation technique is well known to a skilled person in the art, so a detailed description thereof will be omitted.

Meanwhile, in order to connect the first and second coil pattern electrodes 22a and 23a to the first and second leading electrodes 21a and 21b, the first and second via holes are formed in the second insulating sheet 22 and, preferably, filled with the same material as that of a coil conductor pattern to form via electrodes (not shown), respectively.

When the laminate 20 is laminated on the first magnetic substrate 10, a process of forming the hole 20a at a central portion within the laminate 20 is performed as shown in FIG. 4D.

The hole 20a is a space to which the magnetic core 30a formed at the central portion of the second magnetic substrate 30 is to be inserted. The hole 20a may be formed by using any one of a wet etching method, a dry etching method, and a sand blast method, or by using two or more methods thereof.

The substrate made of a magnetic material is chemically very stable, so the thickness etched by the wet etching or the dry etching is not large. Thus, the wet etching method and the dry etching method may be used for the thin type common mode filter.

Thus, when the thickness of the magnetic core 30a is 10 um or more, a dry film may be tightly attached to the second magnetic substrate 30, patterned, and then, etched by using the sand blast method. The magnetic substrate processed through the sand blast method has a somewhat rough surface, but a thickness of tens of um may be etched through the sand blast method. Thus, the sand blast method can be applicable to a case in which the thickness of the magnetic core 30a is large.

In this case, in order to allow the magnetic core 30a to be inserted into the hole 20a, the hole 20a is formed to have the same thickness, the same shape, and the same size as that of the magnetic core 30a.

When the hole 20a is formed at the central portion within the laminate 20, finally, as shown in FIG. 4E, a process of bonding the upper magnetic substrate to the insulating layers is performed such that the magnetic core 30a is inserted into the hole 20a, thus fabricating a completed common mode filter. The bonding process may also be performed by a general thin film formation technique such as screen printing, spin coating, or the like.

The thin film type common mode filter is a coil component optimized for reducing the size of a product, and since it is fabricated by the thin film formation technique, an interval between coil pattern electrodes is merely a few μm and the thickness of the coil pattern electrodes are a few mm, which is very thin. Thus, it is very difficult to provide the magnetic core that improves common mode filter characteristics within the common mode filter based on the related art's wet or dry type fabrication method. However, in the method of fabricating a common mode filter according to an exemplary embodiment of the present invention, since the common mode filter is fabricated by using the magnetic substrate integrally formed with the magnetic core according to an existing thin film formation technique, the common mode filter which is structurally stable and has a high coupling coefficient can be fabricated.

According to the exemplary embodiments of the present invention, since the common mode filter is fabricated by using a magnetic substrate integrally formed with the magnetic core according to an existing thin film formation technique, the common mode filter can be fabricated to be structurally stable and have a high coupling coefficient.

The above detailed description exemplifies the present invention. Further, the above contents just illustrate and describe preferred embodiments of the present invention and the present invention can be used under various combinations, changes, and environments. That is, it will be appreciated by those skilled in the art that substitutions, modifications and changes may be made in these embodiments without departing from the principles and spirit of the general inventive concept, the scope of which is defined in the appended claims and their equivalents. Although the exemplary embodiments of the present invention have been disclosed for illustrative purposes, those skilled in the art will appreciate that various modifications, additions and substitutions are possible, without departing from the scope and spirit of the invention as disclosed in the accompanying claims. Therefore, the detailed description of the present invention does not intend to limit the present invention to the disclosed embodiments. Further, it should be appreciated that the appended claims include even another embodiment.

What is claimed is:

1. A common mode filter comprising:
a first magnetic substrate;
a laminate including insulating sheets with coil pattern electrodes printed thereon, having holes therein, and provided on the first magnetic substrate;
a magnetic core inserted into the hole; and
a second magnetic substrate integrally formed with the magnetic core and provided on the laminate.

2. The common mode filter according to claim 1, wherein the coil pattern electrodes are printed on the insulating sheets such that the electrodes are wound around the magnetic core.

3. The common mode filter according to claim 1, wherein the laminate includes:
a first insulating sheet with first and second leading electrodes printed thereon;
a second insulating sheet laminated on the first insulating sheet and having a first coil pattern electrode printed thereon;
a third insulating sheet laminated on the second insulating sheet and having a second coil pattern electrode printed thereon; and
a fourth insulating sheet laminated on the third insulating sheet.

4. The common mode filter according to claim 3, wherein one end of the first leading electrode is connected to one end of the first coil pattern electrode through a first via hole formed in the second insulating sheet, and one end of the second leading electrode is connected to one end of the second coil pattern electrode through a second via hole formed in the second insulating sheet.

5. The common mode filter according to claim 3, further comprising:
an external electrode terminal formed on a lateral surface of the laminate and connected to the other ends of the first and second leading electrodes and the other ends of the first and second coil pattern electrodes.

6. The common mode filter according to claim 3, wherein the first and second leading electrodes and the first and second coil pattern electrodes are made of at least one material selected from the group consisting of silver (Ag), palladium (Pd), aluminum (Al), nickel (Ni), titanium (Ti), gold (Au), copper (Cu), and platinum (Pt), or a mixture of at least two materials thereof.

7. The common mode filter according to claim 1, wherein the thickness of the magnetic core is equal to that of the laminate, and the shape and size of the magnetic core are the same as the shape and size of the hole.

8. The common mode filter according to claim 1, wherein the first and second magnetic substrates are made of at least one material selected from the group consisting of aluminum oxide (Al₂O₃), aluminum nitride (AlN), glass, quartz, and ferrite, or a mixture of at least two materials thereof.

9. The common mode filter according to claim 1, wherein the insulating sheet is made of at least one material selected from the group consisting of polyimide, an epoxy resin, a benzocyclobutene (BCB), and a polymer, or a mixture of at least two materials thereof.

10. A method of fabricating a common mode filter, the method comprising:
providing a first magnetic substrate and a second magnetic substrate having a magnetic core formed to be outwardly protruded;
providing a laminate configured of insulating sheets with coil pattern electrodes printed thereon on the first magnetic substrate;
forming a hole in the laminate; and
bonding the second magnetic substrate to the laminate such that the magnetic core is inserted into the hole.

11. The method according to claim 10, wherein the laminate is formed by performing:
printing first and second leading electrodes on a first insulating sheet;
printing a first coil pattern electrode on a second insulating sheet;
printing a second coil pattern electrode on a third insulating sheet; and
sequentially depositing the first to third insulating sheets and the fourth insulating sheet starting from a lower surface thereof.

12. The method according to claim 11, wherein the first and second leading electrodes and the first and second coil pattern electrodes are printed by any one of photolithography, e-beam, focused ion-beam, lithography, dry etching, wet etching, and nano-implant.

13. The method according to claim 10, wherein the forming of the hole in the laminate is performed by using any one of a wet etching method, a dry etching method, and a sand blast method, or by using two or more methods thereof.
